(19) United States
(12) Patent Application Publication
(10) Pub. No.: US 2015/0091812 A1
(43) Pub. Date: Apr. 2, 2015

(54) CONTROLLING A COMPUTING DEVICE USING A TAP SEQUENCE AS USER INPUT

(71) Applicant: Kobo Inc., Toronto (CA)

(72) Inventors: Ryan Sood, Toronto (CA); Damian Lewis, Toronto (CA)

(73) Assignee: Kobo Inc., Toronto (CA)

(21) Appl. No.: 14/041,903

(22) Filed: Sep. 30, 2013

(51) Int. Cl. G06F 3/041

(52) U.S. Cl. CPC G06F 3/041; G06F 2203/04104
USPC 345/173

(57) ABSTRACT

A computing device detects a tap sequence that is provided by a user as input on a housing of the computing device. The tap sequence includes multiple taps, and each tap in the sequence corresponding to an object of the user (e.g., finger or stylus) impacting the housing. From the tap sequence, the computing device determines one or more characteristics of the tap sequence. The computing device selects a command based at least in part on the number of taps in the sequence, and the computing device performs an operation based on the command.

### TECHNICAL FIELD

Examples described herein provide for controlling a computing device using a tap sequence as user input.

### BACKGROUND

Multi-function portable computing devices include various resources for enabling user-interaction. Among the resources, such devices typically carry sensors to detect movement and touch, as well as display screens that are touch-sensitive.

### BRIEF DESCRIPTION OF THE DRAWINGS

FIG. 1 illustrates a system for operating a computing device, according to an embodiment.

FIG. 2 illustrates an example of a mobile computing device, according to an embodiment.

FIG. 3 illustrates a device system for transitioning pages of paginated content displayed on a computing device, according to one or more embodiments.

FIG. 4A illustrates an example method for controlling a computing device using a tap sequence.

FIG. 4B illustrates an example method for configuring a computing device to respond to tap events.

FIG. 5A illustrates a first example of a tap event.

FIG. 5B illustrates a second example of a tap event

### DETAILED DESCRIPTION

Examples described herein relate to controlling a computing device using a tap sequence as user input. More specifically, examples described herein include a computing device that can interpret a series or sequence of taps as input in performing a selected operation.

In embodiment, a computing device detects a tap sequence that is provided by a user as input. The tap sequence can be provided on a housing of the computing device. The tap sequence includes multiple taps, where each tap in the sequence corresponding to an object of the user (e.g., finger or stylus) impacting the housing. From the tap sequence, the computing device can determine one or more characteristics. The computing device selects a command based at least in part on the number of taps in the sequence, and then performs an operation specified by the command.

According to some embodiments, the computing device detects one or more characteristics of the tap sequence. In one implementation, the one or more detected characteristics correspond to a number of taps in the sequence. In a variation, the computing device detects one or more characteristics of the tap sequence that correspond to a pattern in the sequence of taps.

In some embodiments, the computing device detects the tap sequence using one or more sensors that are positioned to detect tap events on an exterior of the housing. For example, sensors can be positioned on a front face of the housing and/or on a back face of the housing.

As used herein, a “tap” in the context of a computing device refers to an impact by an object (such as a finger) with an exterior of the computing device. In at least some embodiments, a tap is interpreted as a binary event, and multiple taps in a series can be interpreted as a binary series or sequence.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

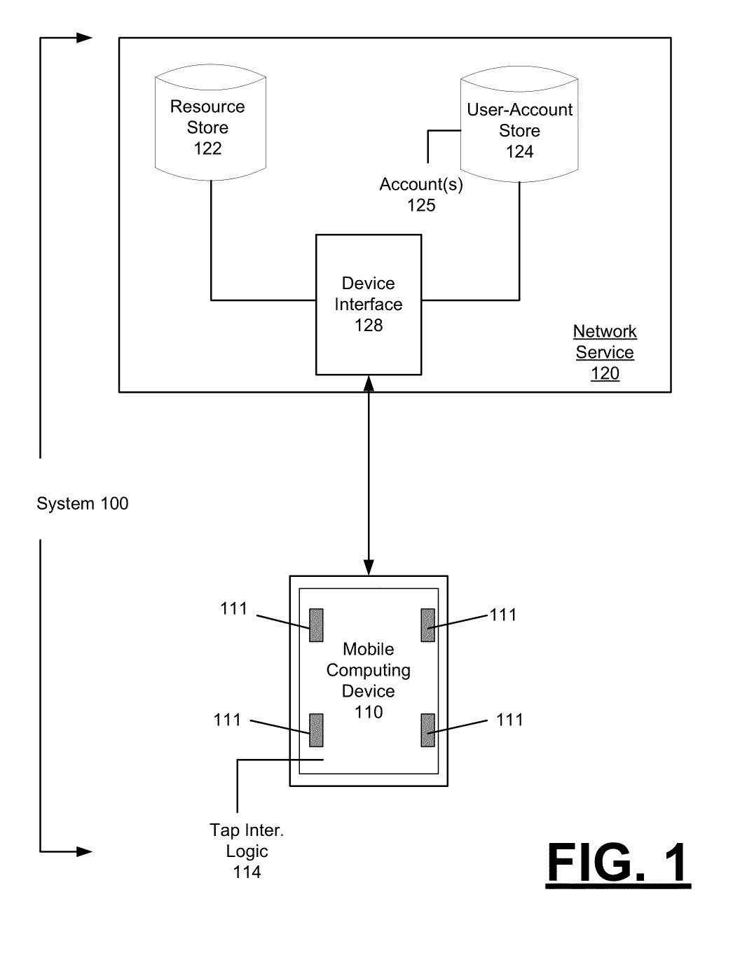

FIG. 1 illustrates a system for operating a computing device, according to an embodiment. A system 100 includes a mobile computing device 110 and a network service 120. The network service 120 may include multiple servers and other computing resources that provide various services, including services in which digital content items (e.g., e-books) are sold, shared, downloaded and/or stored. According to embodiments, the mobile computing device 110 includes resources to receive and process tap events (e.g., series or sequence of taps) as input. More generally, the mobile computing device 110 can correspond to any computing device that can process input and provide output. For example, the mobile computing device 110 can correspond to a tablet, telephony/messaging device (e.g., smart phone) or portable computing device. The mobile computing device 110 can run an operating system on which multiple applications are installed, including an application that links the device to the network service 120. The application can receive services and other functionality from the network service.

In some implementations, the mobile computing device 110 is equipped with hardware and software to optimize activities received from the network service 120 (e.g., reading electronic content, including e-books). The mobile computing device 110 can have a tablet like form factor, although variations are possible. In some cases, the mobile computing device 110 can also have an E-ink display.

The network service 120 can include a device interface 128, which communicates with individual devices that access the service. Among other resources, the network service 120 can include a resource store 122 and a user account store 124. The user account store 124 can associate mobile computing device 110 with a user and an account 125. The account 125 can also be associated with resources (e.g., digital content items such as e-books) of the resource store 122. As described further, the user account store 124 can retain metadata for individual accounts 125 to identify resources (e.g., digital content items or e-books) that have been purchased or made available for consumption for a given account. The mobile computing device 110 may be associated with the user account 125, and multiple devices may be associated with the same account.

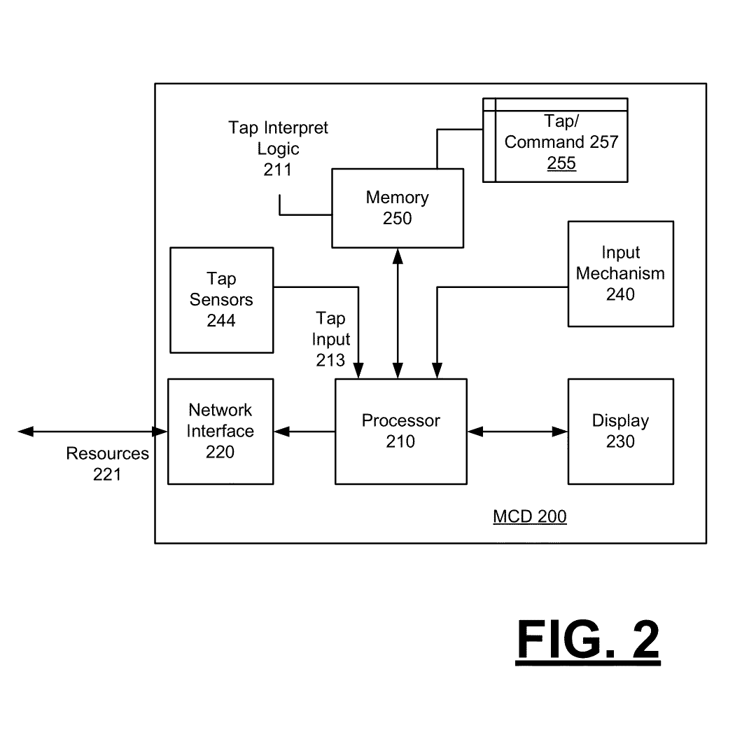

In some embodiments, mobile computing device 110 includes tap sensors 111 and tap interpretation logic 112. The tap sensors 111 include one or more accelerometers, touch sensors, force sensors, or a combination thereof. Multiple tap sensors 111 can be provided to detect tap events that occur on one or more regions of the housing of the mobile computing device 110. As described with an example of FIG. 2, an orientation of the tap sensors 111 can be integrated with the housing shell of the mobile computing device 110. Alternatively, the tap sensors 111 can be provided within the housing of the mobile computing device 110 and oriented to detect tap events that occur on the exterior of the housing shell.

The tap interpretation logic 112 of the mobile computing device 110 can be used to interpret a series or sequence of taps as input. In some embodiments, the tap interpretation logic 112 can be executed by a processor of the mobile computing device 110 which communicates with the individual tap sensors 111. In some implementations, the tap interpretation logic 112 can be implemented as an application or application logic. In particular, the tap interpretation logic 112 can alternatively be provided as part of an application for communicating with the network service 120.

FIG. 2 illustrates an example of a mobile computing device, according to an embodiment. A mobile computing device 200 as described with an example of FIG. 2 can be used to implement a system such as described with FIG. 1. The mobile computing device 200 can include a processor 210, a network interface 220, a display 230, one or more input mechanisms 240, and a memory 250. Additionally, the mobile computing device 200 can include tap sensors 244. The processor 210 can utilize the network interface 220 to communicate with a network service 120 (see FIG. 1). In communicating with the network service 120, the mobile computing device 110 can receive resources 221, such as digital content items, that the user has purchased or otherwise selected to download from the network service 120. The resources 221 that are downloaded onto the mobile computing device 110 may be stored in the memory 250.

The display 230 can correspond to, for example, a liquid crystal display (LCD) that illuminates in order to provide content generated from processor 210. In alternative variations, for example, the display 230 can correspond to an electronic paper type display, which can be designed to mimic conventional paper in the manner in which they display content. Examples of such display technologies include electrophoretic displays, electrowetting displays, and electrofluidic displays. Examples described herein further appreciate that the media in which electronic type displays are provided can vary, and include, for example, plastic or paper combined with transistor elements or other circuitry.

The tap sensors 244 can correspond to accelerometers, touch sensors, force sensors or combinations thereof, and the combination of tap sensors 244 can be oriented to detect tap events on an exterior of the mobile computing device 200. In some variations, some or all of the sensors used to detect taps as input are integrated with the display 230. The tap sensors 244 can interpret tap events as a tap input 213. Each tap input 213 can identify a series or sequence of taps. The memory 250 can store data structure 255, which references characteristics of tap events to commands 257. The tap input 213 can identify a characteristic of a tap series or sequence. The characteristics can include, for example, a number of taps in the sequence, or a pattern or cadence that is present in at least a portion of the tap event.

The processor 210 can reference the tap input 213 to a command 257 using the data structure 255, then perform an operation specified by the command. By way of example, the operations that can be performed include switching the power state of the computing device 200 (e.g., switch the computer from sleep or “off” state to high power state), open menu and navigate menu, and/or e-book activity input. Specific examples of e-book activity input include page transitioning input.

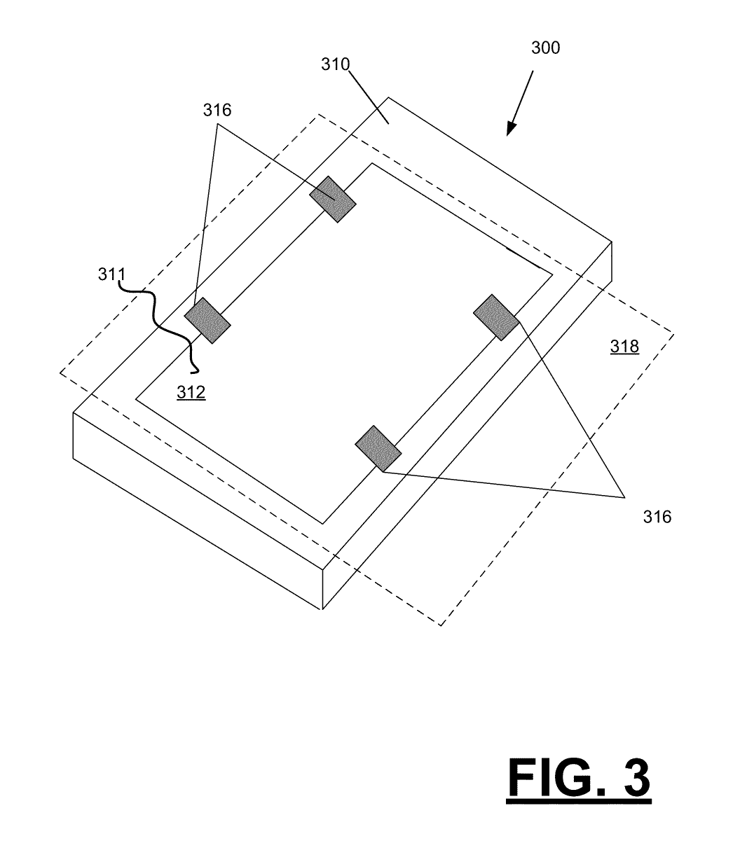

FIG. 3 illustrates a mobile computing device that is configured in accordance with one or more embodiments. A mobile computing device 300 as described with an example of FIG. 3 can be used to implement a system such as described with FIG. 1, and a mobile computing device such as described with FIG. 2. In more detail, the computing device 300 includes a housing shell 310 which can include housing features such as a touchscreen display surface 312. Other housing features include, for example, buttons or switches provided on the housing shell 310.

In an embodiment, the housing shell 310 includes a set of sensors 316. The sensors 316 can correspond to, for example, accelerometers. The sensors 316 can be embedded within the housing shell 310. Alternatively, the sensors 316 may be integrated or otherwise embedded in the housing shell 310. In variations, the sensors 316 include touch sensors, force sensors or other sensors that are capable of detecting taps. The sensors 316 can be oriented relative to an exterior of the housing shell 310 to detect tap events (e.g., the user generating a tap event 311 on the housing shell 310 that can be interpreted as a tap sequence). The sensors 316 can provide sensor regions 318 where tap events 311 can be detected. For instance, in an example of FIG. 3, the sensor region 318 can overlay a front surface of the housing shell 310, so as to overlap the display surface 312. As an alternative or variation, the sensor regions 318 can overlay a back surface of the housing shell 310. In this way, the exterior of the mobile computing device 300 can be used to detect and process user-initiated tap events as commands. The taps can be provided independent of, for example, button presses or touch screen interactions.

In some variations, the sensor region 318 for detecting the tap events 311 can overlap the touchscreen display surface 312. However, the tap events 311 can be detected using sensors 316 that operate independent of touch sensors that may be integrated with the touchscreen display. Additionally, the tap events 311 can be detected as binary events, rather than, for example, touchscreen input. As binary events, information such as position information is not included in the interpreted values of the tap events. Rather, tap events can be processed as a series or sequence of binary events, and the series or sequence can carry characteristics such as number, pattern or cadence.

Methodology

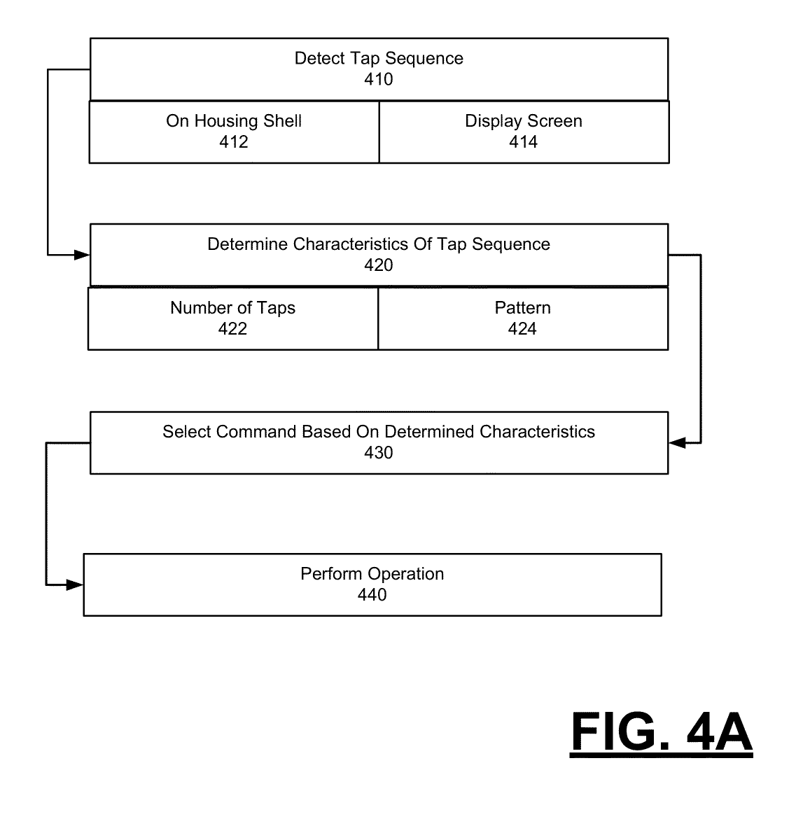

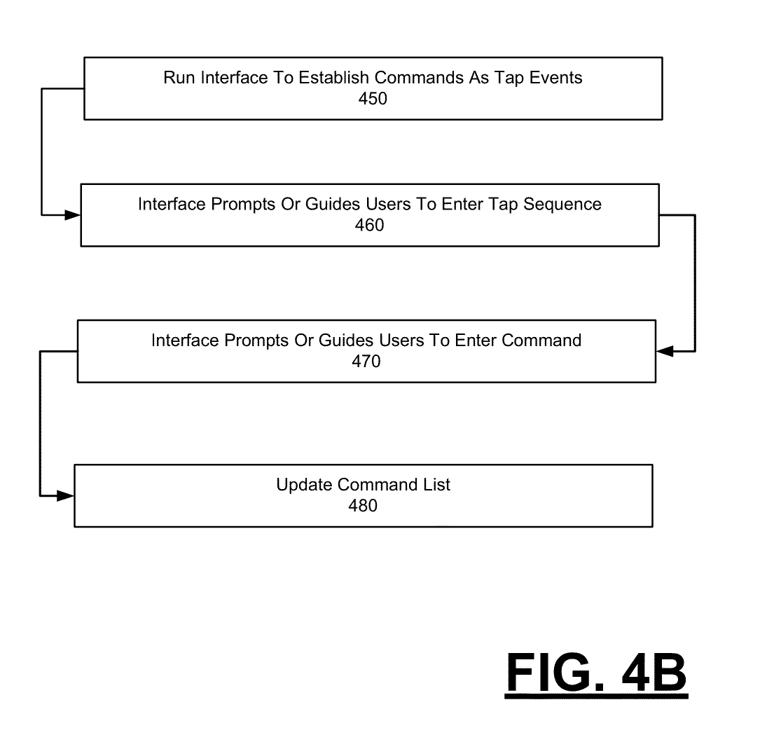

FIG. 4A illustrates an example method for controlling a computing device using a tap sequence. FIG. 4B illustrates an example method for configuring a computing device to respond to tap events. A method such as described with examples of FIG. 4A or FIG. 4B may be implemented using components such as described with FIG. 1, FIG. 2 or FIG. 3. Accordingly, reference may be made to elements of other figures for purpose of illustrating suitable elements or components for performing a step or sub-step being described.

With reference to FIG. 4A, a computing device operates to detect a tap sequence (410). The tap sequence can correspond to multiple taps being entered onto the computing device by a user. In one implementation, the tap sequence can be entered onto the housing shell 310 of the computing device 200 (412). For example, touch sensors can be embedded into the back or front face of the housing shell 310 to detect finger taps from the user. Alternatively, a set of accelerometers within the device can detect impacts resulting from tap events. As an alternative to detecting tap events on the housing shell 310, some implementations provide for detecting tap events that occur on the display surface 312 of the computing device (414). For example, the touch sensors of the mobile computing device can detect tap events resulting from contact by the user finger on the display surface 312. With reference to an example of FIG. 2, the processor 210 can separately process the tap events on the display screen as a tap sequence, rather than a touchscreen input.

Once detected, the computing device 200 can determine the characteristics of the tap sequence (420). In one implementation, the characteristics that are determined include identifying a number of taps in the sequence (422). In a variation, the processor 210 can analyze the tap sequence to identify a number of consecutive taps after an initial tap. In another variation, the processor 210 can analyze the tap sequence to identify a pattern in the tap sequence (424).

The processor 210 of the computing device can select a command based on the determined characteristics of the tap sequence (430). In one implementation, the computing device can include a default set of commands paired with tap sequences. Alternatively, tap sequences can be established for commands in accordance with a method such as described with FIG. 4B.

The computing device can then perform an operation corresponding to the command (440). By way of example, the computing device can switch “on” (e.g., switch from a sleep or low-power state to a high power state), open a designated application, close a designated application, etc. As another example, tap events can be used to implement menu functions. Still further, the tap events can be interpreted as input in a conditional manner. In particular, a first conditional tap event can be detected before subsequent taps are interpreted as a particular type of input. For example, a first sequence of taps can cause the processor 210 to open a menu, and subsequent taps can result in the processor 210 cycling through menu options and/or selecting a particular menu option.

The tap sequence can also be specified for application-specific input. For example, in an implementation in which the mobile computing device 200 runs an e-reader program to view e-books provided from the network service 120, tap events can be used to implement page transitions, chapter transitions, or perform other actions. For example, a single or double tap can result in a single page turn. Multiple taps can result in a chapter transition or other mufti-page transition. Among other benefits, examples such as described herein provide benefit in the context of e-books, which users often prefer to use with one hand. A user can hold an e-reader (or tablet) with one hand, and tap a non-display surface of the e-reader (e.g., back surface, front edge) to signal a tap event. Sensors on the e-reader can detect events and implement operations such as page transitions. For example, a single tap (or alternatively multiple taps) on a non-display surface of the e-reader can be equated to a single page turn, and a double tap can be equated to a chapter transition. In this way, the user can operate the e-reader to view e-books using a single hand, rather than using one hand to hold the device and a second hand to transition pages or chapters (e.g., by touching the displays screen of the e-reader).

In the context of digital content items such as music or video playback activities, the processor 210 can respond to tap events by pausing playback, transitioning to next songs/videos, replaying or performing other tasks. Among other benefits, examples recognize that media playback devices are often small, and the ability of the user to enter input while holding the device with one hand can enhance the usability of such devices.

With reference to FIG. 4B, the mobile computing device 110 execute an interface to enable a user to establish commands for tap events (450). The interface can, for example, be provided by a setup application that runs on the device. With reference to an example of FIG. 1, the setup application can be provided from the network service 120. The interface can prompt or otherwise guide a user into entering a tap sequence (460). For example, the interface can initiate a listening period, and then prompt the user to enter the tap sequence during that period. Additionally, the interface can enable the user to select a command or operation to be performed for the particular tap sequence (470). Once the user enters the operation, a command list can be updated to reflect the tap sequence (480). For example, with reference to FIG. 2, the data structure 255 can, for example, be updated to reflect the command and the tap event.

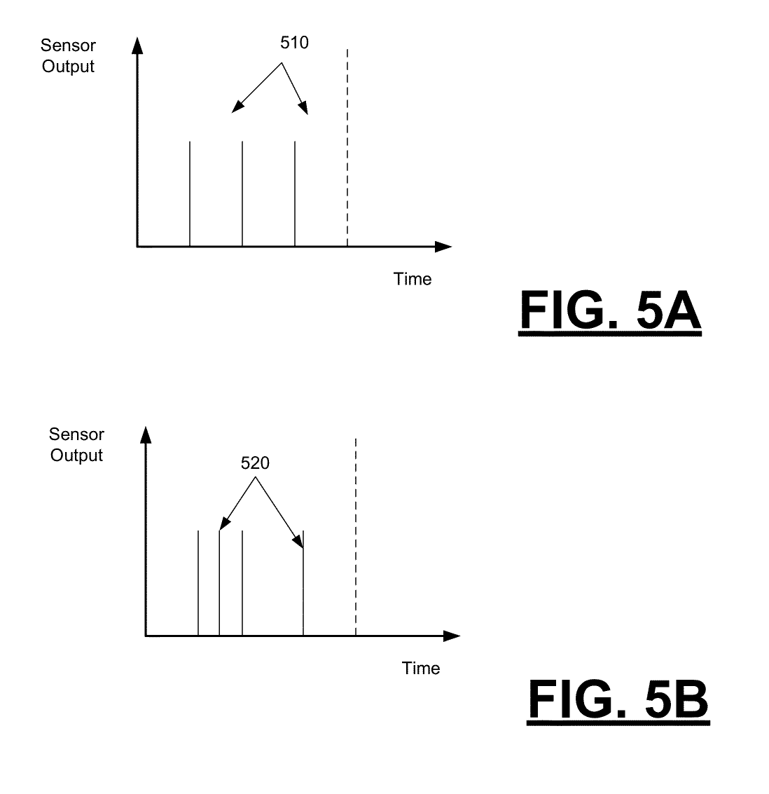

FIG. 5A illustrates a first example of a tap event. In the example of FIG. 5A, the tap sequence 510 can be analyzed to identify a number of taps that occur over a given duration. The number of taps can correspond to a command. For example, a first number of taps can correspond to a first command, and a second number of taps can correspond to a second commands. With reference to FIG. 2, the processor 210 can analyze the tap sequence to identify a number of taps that occur over a given duration (e.g., 3 taps in 3 seconds), and then perform an operation based on the specified command.

FIG. 5B illustrates a second example of a tap event. In the example of FIG. 5B, the tap sequence 520 can be detected and analyzed to identify a pattern in the taps that occur over a given duration. For example, as illustrated in example of FIG. 5B, a tap sequence 520 includes a pattern of 3 taps with short time spans (e.g., less than 1/10^{th} of a second) in between the individual taps, then a single tap that follows a longer time span (e.g., e.g., between half and full second). The pattern, which includes determining the length of time between taps in a given sequence, can be analyzed and equated to a signature. The signature can then be matched to one of multiple possible stored signatures. If a match is found, the processor 210 can determine the command for the tap sequence 520.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for controlling a computing device, the method being implemented by one or more processors of the computing device and comprising:
detecting a tap sequence provided on a housing of the computing device, the tap sequence including a plurality of taps, and each tap in the tap sequence corresponding to an object impacting the housing;
determining one or more characteristics of the tap sequence;
selecting a command based at least in part on the one or more characteristics of the tap sequence; and
performing an operation based on the command.

2. The method of claim 1, wherein determining one or more characteristics of the tap sequence includes determining a number of taps in the tap sequence.

3. The method of claim 1, wherein determining one or more characteristics of the tap sequence includes determining a pattern in the tap sequence, and wherein selecting the operation is performed based at least in part on the pattern.

4. The method of claim 1, wherein detecting the tap sequence is performed using one or more sensors that are oriented relative to the housing of the computing device to sense an impact on the housing.

5. The method of claim 4, wherein the one or more sensors include one or more accelerometers.

6. The method of claim 1, further comprising storing a data structure that associates each of a plurality of tap sequences to a corresponding command in a plurality of commands.

7. The method of claim 6, further comprising enabling a user to specify at least one of the plurality of tap sequences.

8. The method of claim 7, further comprising enabling the user to also specify a command for each of the specified tap sequences.

9. The method of claim 1, wherein performing the operation includes switching a power state of the computing device.

10. The method of claim 1, wherein performing the operation includes performing a menu operation.

11. The method of claim 1, wherein performing the operation includes performing (i) opening an e-book, (ii) opening a library view of a collection of e-books, or (iii) transitioning a page or chapter of the e-book.

12. A computing device comprising:
a housing;
a memory, the memory storing a set of instructions and a command list;
a set of sensors to detect a tap event on the housing of the computing device;
a processor to:
use the set of sensors to detect a tap sequence provided on the housing of the computing device, the tap sequence including a plurality of taps, and each tap in the tap sequence corresponding to an object impacting the housing;
determine one or more characteristics of the tap sequence;
select a command based at least in part on the one or more characteristics of the tap sequence; and
perform an operation based on the command.

13. The computing device of claim 12, wherein the one or more processors determine the one or more characteristics of the tap sequence by determining a number of taps in the tap sequence.

14. The computing device of claim 12, wherein the one or more processors determine the one or more characteristics of the tap sequence by determining a pattern in the tap sequence.

15. The computing device of claim 14, wherein the one or more processors select the command based at least in part on the pattern.

16. The computing device of claim 12, wherein the set of sensors are oriented relative to the housing of the computing device to sense an impact on the housing.

17. The computing device of claim 16, wherein the set of sensors includes one or more accelerometers.

18. The computing device of claim 12, wherein the one or more processors perform a menu operation based on the command.

19. The computing device of claim 12, wherein the one or more processors performing the operation corresponding to one of (i) opening an e-book, (ii) opening a library view of a collection of e-books, or (iii) transitioning a page or chapter of the e-book.

20. A computer-readable medium that stores instructions for controlling a computing device, the instructions being executable by one or more processors in performing operations that comprise:
detecting a tap sequence provided on a housing of the computing device, the tap sequence including a plurality of taps, and each tap in the tap sequence corresponding to an object impacting the housing;
determining one or more characteristics of the tap sequence;
selecting a command based at least in part on the one or more characteristics of the tap sequence; and
performing an operation based on the command.
